(19) United States
(12) Patent Application Publication
(10) Pub. No.: US 2002/0095839 A1
(43) Pub. Date: Jul. 25, 2002

(54) Outdoor signage for visually impaired

(76) Inventors: Robert H. Allen, JR., Greensboro, NC (US); Wayne J. Jones, High Point, NC (US); Martin M. Kramer, Kernersville, NC (US)

Correspondence Address: RHODES & MASON, P.L.L.C., P.O. BOX 2974, GREENSBORO, NC, 27402, US

(21) Appl. No.: 09/728,331

(22) Filed: Dec. 1, 2000

(51) Int. Cl. G09B 21/00; G09F 7/00

(52) U.S. Cl. 40/584; 434/113

(57) ABSTRACT

Architecturally aesthetic signage having a sufficient hardness that upon interaction with an etchent results in a plurality of smooth tiers or terraces resulting in both visual and tactile indicia for communication with an observer is disclosed. In the preferred embodiment, the tactile and visual indicia comply with the requirements of the Americans for Disabilities Act. The signage is preferably formed by an etcher system including: an etchent delivery; an etchent; a substrate holder; a substrate having sufficient hardness that upon interaction with the etchent produces the visual indicia for communication with an observer; and a controller for controlling the delivery of the etchent onto the substrate to form the signage.

### BACKGROUND OF THE INVENTION

(1) Field of the Invention

The present invention relates generally to signage and, more particularly, to a method and apparatus for producing raised signage that meets the requirement of the American for Disabilities Act.

(2) Description of the Prior Art

Architectural signage communicates to an observer through its context whether it is visual or written. It is important for signage to contain an aesthetic aspect in that the visual or aesthetic component adds to presenting the message at hand either for the particular point to be made or within the context of an environment. In 1992 the Federal Government passed the Americans for Disabilities Act (ADA), which created additional challenges in the design of architectural signage. In particular, the ADA has specific requirements that challenge the designer. Among these requirements are:

“ . . . letters and numbers shall have a width to height ratio between 3:5 and 1:1 and a stroke-to-height ratio between 1:5 and 1:10; character height, as sized according to the viewing distance . . . 0.032″raised lettering not less than 5/8″height, no higher than 2″; and symbols in their own 6″ high field and accompanied with Grade II Braille. Braille dot diameter 0.059″, inter-dot spacing 0.090″, horizontal separation between cells 0.241″, vertical separation between cells 0.395″. Characters and background of sign shall be an eggshell or matte (non-glare) finish. Characters shall meet a minimum 70% contrast to background.”

The ADA specifically requires that with respect to signage, the alpha numerical text and symbols printed on the signs must be formed to comply with certain size and viewing distance requirements. In particular, the text and characters nust be in relief, i.e. projecting from the surface of the signage, in order to comply. This construction and arrangement enables those with limited eyesight to discern or finger trace the signage and the messages conveyed, as well as enable the blind to read Braille characters of the signage. In this sense, the ADA requires that in public places as well as certain private locations, that signage communicate to people having visual imparities such as partial blindness and total blindness. The designer is thus challenged to communicate to the seeing, the partially blind, and the totally blind. Further, the designer is challenged to communicate to the literate and illiterate of these groups. To accomplish this, the designer wants to clearly communicate to all groups in a way that does not create distractions for any one group.

Businesses have attempted various approaches in making signage to meet ADA requirements. One technique includes enameled metals. Other techniques use photopolymers. These materials have been found to be particularly advantageous in that they allow the creation of tiered surfaces including a sharp contrast between the background and the symbolic indicia. A major drawback of such signage is that the same chemistry or technology that allows the creation of unique and architecturally aesthetic signage is its weakness. That is, photopolymers are susceptible to environmental factors such as environmental chemistry, radiation and thermophysical fluctuations.

With respect to environmental chemistry, the acid compounds in air pollution are known to adversely effect polymers and even more so, photopolymers. With respect to radiation, the manufacturing advantage and flexibility of using radiation to create objects from photopolymers works to their detriment when exposing the resultant objects to solar radiation, including ultraviolet radiation that can result in the objects' degradation.

The thermophysical fluctuations of the environment include thermal cycling. This is particularly an issue in the application of signage in areas where there is a large variation in temperature, for example, the extreme northern and southern United States where the temperature varies from substantially below freezing to temperatures above 90° F. and even above 100° F.

Another aspect of these photopolymers is their susceptibility to humidity, which may be a factor in chemical degradation, that may be an additive factor in that moisture can adversely affect these photopolymers.

Thus, there remains a need for a new and improved signage that meets the requirement of the American for Disabilities Act which is environmentally stable while, at the same, reducing the labor, materials and maintenance costs of the signage. New and improved environmentally stable signage may withstand environmental factors such as environmental chemistry including acid compounds in air pollution, radiation including solar radiation and thermophysical fluctuations including thermal cycling discussed above. A new and improved method and apparatus for producing such environmentally stable signage has been developed.

### SUMMARY OF THE INVENTION

The present invention is directed to an environmentally stable, architecturally aesthetic signage. The signage comprising a substrate having sufficient hardness that upon interaction with an etchent results in a plurality of raised, smooth surfaces resulting in both visual and tactile indicia for communication with an observer that will survive longer in an outdoor environment. In the preferred embodiment, the tactile and visual indicia comply with the requirements of the Americans for Disabilities Act. Also, the tactile indicia corresponds to the visual indicia.

In the preferred embodiment, the smooth surfaces are further tiered or terraced. The smooth surfaces may be a tier or terrace in the sense of a flat or open surface adjoining another surface, usually one of a layered series. The tier or terrace may create an effect in the signage where surfaces rise one above another via vertical or sloping steps. A tier or terrace may be a generally flat, long and narrow surface bordered on at least one side by a steep ascending or descending slope and, optionally, on the other side by a steep descending or ascending slope. In a preferred embodiment, a steep ascending or descending slope is substantially perpendicular to an adjoining surface. There may also be a first color coating on a first terrace and a second color coating on a second terrace. Preferably, the indicia includes lettering wherein the indicia is formed from a second color coating different from the first color coating and may further include a clear coat over at least the lettering portion of the signage.

Also, in the preferred embodiment, the substrate is formed from a polymer. The polymer may include a filler, such as an oxide of aluminum such as aluminum trihydrate. Preferably, the particle size of the filler is large enough to permit etching and small enough to permit the formation of clear distinguishing smooth surfaces. The polymer may be an acrylic polymer, a polyester polymer or a methyl methacrylate polymer. One particularly suitable filled polymer is CORTAN® plastic sold by Dupont of Wilmington, Del. and, another is Carolite™ plastic sold by Carolina Custom Surfaces of Greensboro, N.C.

Accordingly, one aspect of the present invention is to provide an architecturally aesthetic signage for complying with the requirements of the Americans for Disabilities Act, the signage comprising a substrate having sufficient hardness that upon interaction with an etchent results in a plurality of smooth surfaces resulting in both visual and tactile indicia for communication with an observer.

Another aspect of the present invention is to provide an etcher system for forming a substrate for use in an architecturally aesthetic signage complying with the requirements of the Americans for Disabilities Act, the system comprising: an etchent delivery; an etchent; a substrate holder; a substrate having sufficient hardness that upon interaction with the etchent results in a plurality of smooth surfaces resulting in visual indicia for communication with an observer; and a controller for controlling the delivery of the etchent onto the substrate to form the signage.

Still another aspect of the present invention is to provide a method for forming a substrate for use in an architecturally aesthetic signage complying with the requirements of the Americans for Disabilities Act, the method comprising the steps of: providing an etchent delivery; providing an etchent; providing a substrate holder; providing a substrate having sufficient hardness that upon interaction with the etchent results in a plurality of smooth surfaces resulting in visual indicia for communication with an observer; and controlling the delivery of the etchent onto the substrate to form the signage.

These and other aspects of the present invention will become apparent to those skilled in the art after a reading of the following description of the preferred embodiment when considered with the drawings.

### BRIEF DESCRIPTION OF THE DRAWINGS

FIG. 1 is a front view of signage produced according to the present invention;

FIG. 2 is a cross sectional view of the signage in FIG. 1, taken along lines 2-2;

FIG. 3 is a cross sectional view of the signage in FIG. 1, taken along lines 3-3;

FIG. 4 is a cross sectional view of the signage in FIG. 1, taken along lines 4-4;

FIG. 5 is a schematic diagram of an etcher system for producing raised signage shown in FIG. 1;

FIG. 6 is a flow chart for a method for producing raised signage shown in FIG. 1; and

FIG. 7 is a flow chart for a control system for controlling the etcher shown in FIG. 5.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

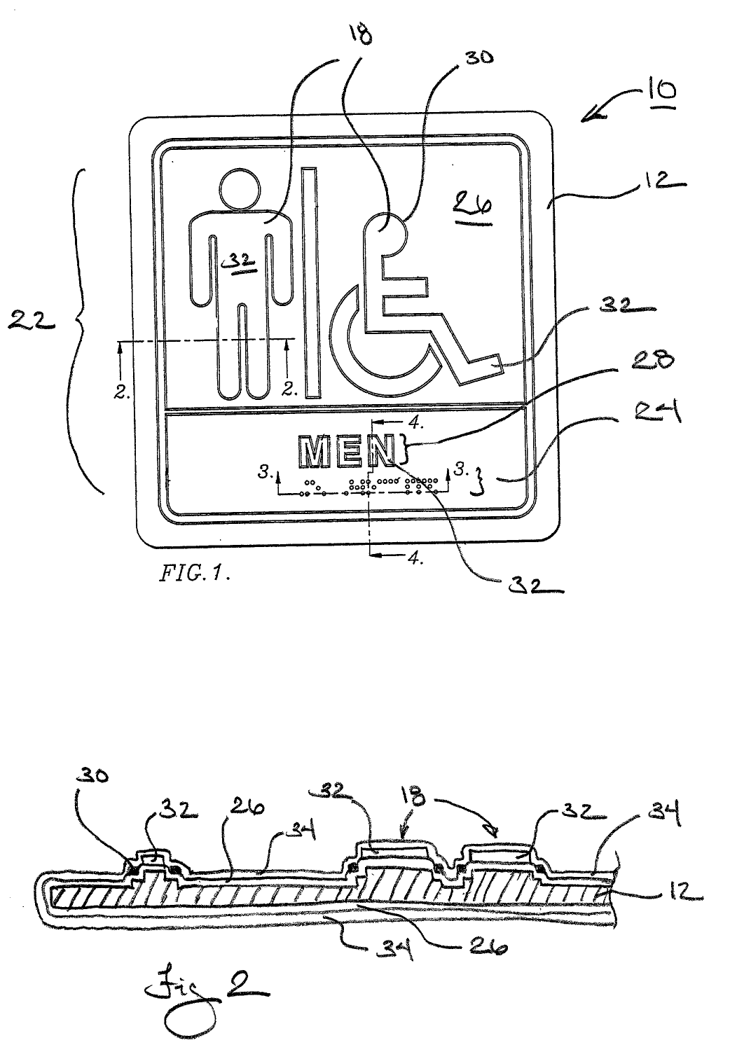

Referring now to the drawings in general and FIG. 1 in particular, it will be understood that the illustrations are for the purpose of describing a preferred embodiment of the invention and are not intended to limit the invention thereto. As best seen in FIG. 1, signage, generally designated 10, is shown constructed according to the present invention. The signage 10 includes a substrate 12 having communicative indicia 22 such as symbolic indicia 18, tactile indicia 24, and alphanumeric indicia 28.

The purpose of this signage 10 is to communicate, as in this specific example, the location of a Men's room including a handicapped access to any seeing, partially blind, and totally blind observer, whether literate or illiterate, in a way that does not create distractions for any one group. However, Applicants contemplate that any signage within a public or private facility that is regulated by the Americans for Disabilities Act is included in the present invention. For instance, signage for identifying room numbers, specifying locations of concessions, as well as including corporate logos or aesthetic artwork to add to the visual or aesthetic experience of the observer.

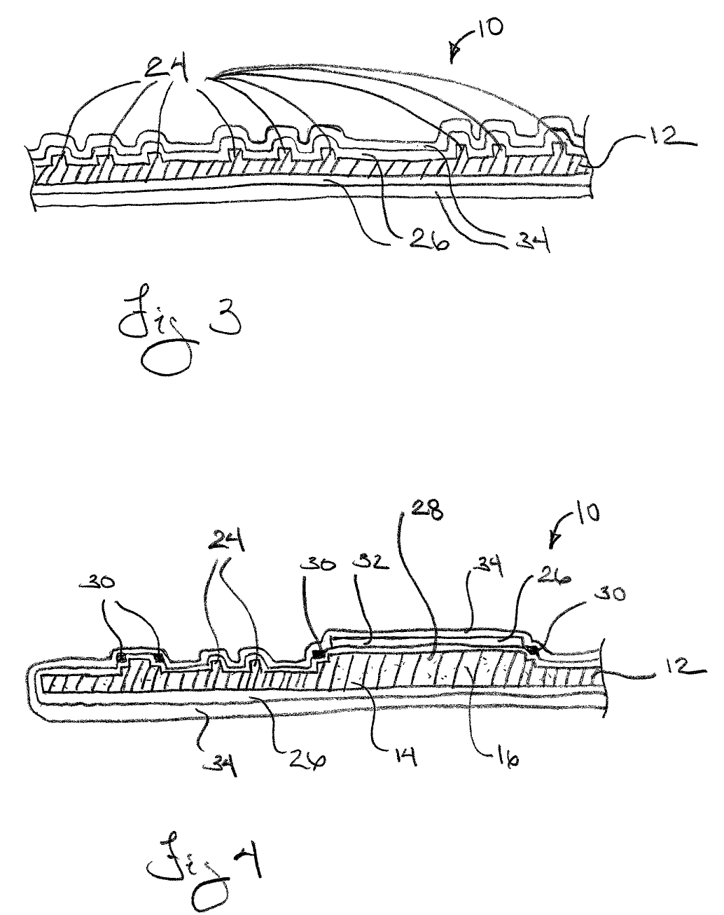

Now referring to FIG. 2, it depicts the cross-sectional section of the signage 10 at location 2. The cross section shows a substrate 12 coated with a first color layer 26 on a lower tier or terrace, an optional next level tier or terrace and an upper tier or terrace. An optional color layer 30 of a different color may be included on the optional next level tier to create, for example, a rim or shadow effect. The upper tier or terrace, which includes symbolic indicia 18 and alphanumeric indicia 28, is covered with a second colored layer 32. The second colored layer 32 used for alphanumeric indicia 28 may be the same as or different from the second colored layer 32 used for the symbolic indicia 18. Both colors are different from that of the first color layer 26. The entire surface of the signage 10 is then covered with a clear coat 34. The selection of the color for the first color layer 26 and the optional color layer 30 may be such to add aesthetic features to the signage 10. The selection and placement of the color of the second colored layer 32 on the first color layer 26 is such as to meet the requirements of the Americans for Disabilities Act and, more importantly, communicate the information of signage 10 to any seeing, partially blind, and totally blind observer, whether literate or illiterate, in a way that does not create distractions for any one group.

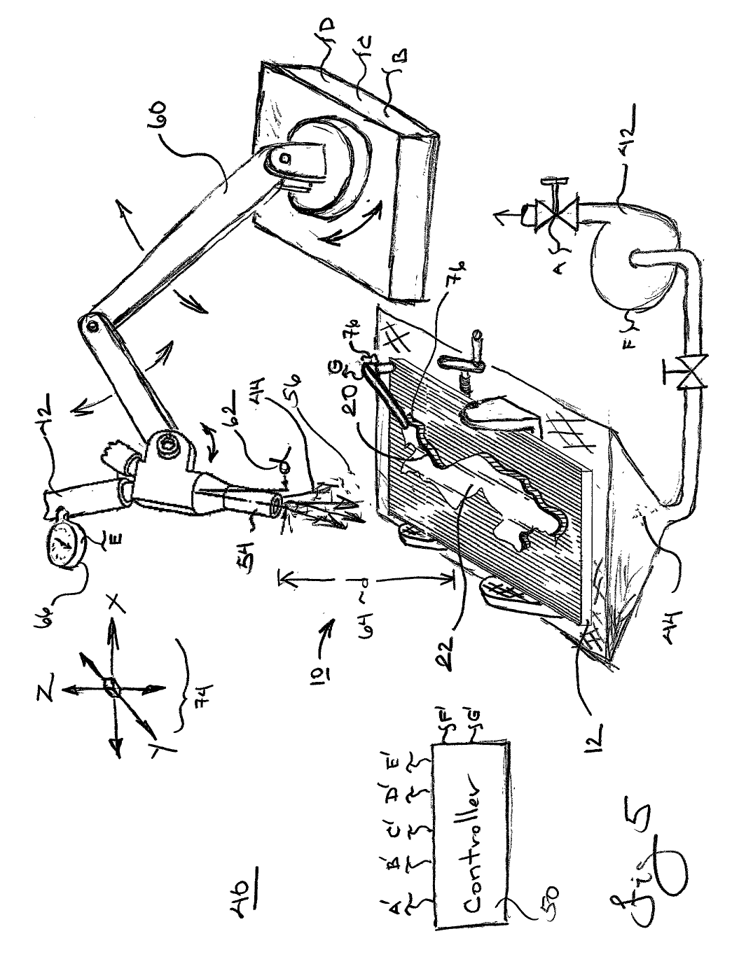

The function of clear coat 34 is to provide protection to first color layer 26, optional color layer 30, and the second colored layer 32 to extend the signage life. Similar features are depicted in FIGS. 3 and 4, which are cross sections at locations 3 and 4 of signage 10 depicted in FIG. 1. Note that the tactile indicia 24 of the figures is not solely the Braille lettering but may also include symbolic indicia 18 and alphanumeric indicia 24. Coloring the Braille lettering is optional in that the communication is via its touch and feel, and it may be better to not color the Braille lettering so as no to distract the seeing observer.

The lettering depicted in signage 10 is of a size to be seen by those with visual impairments such as the partially blind. In addition, it is beneficial for the lettering to have a distinct step from the lower tier or terrace to the upper tier or terrace. This provides an additional method for the visually impaired to verify the content of the signage. Such persons, while being Braille illiterate, may be able to touch the lettering to make out what the letters are to gain an understanding or clarification of the signage 10.

To create signage 10 according to the present invention it is beneficial to use a substrate 12 that is not adversely affected by the environmental effects discussed above. In particular, it is beneficial to use a substrate 12 that is resistant to the environmental chemical aspects to an environmental thermophysical variation, as well as environmental radiation. In particular, the substrate 12 material would be of the type that is not adversely affected by ultraviolet radiation. In the case that the signage may be used in a facility including other manmade radiation sources, such as medical and chemical diagnostics equipment that includes x-ray radiation, nuclear magnetic radiation, and other forms of photon or electron radiation, the substrate 12 would be selected in way to survive these environments.

In regard to the substrate 12, it is selected to have a hardness that allows it to be processed in an etching technique that results in signage having communicative indicia that is relieved from the surface to meet the requirements of the Americans for Disabilities Act. Applicants have found that polymer substrates work well even though photopolymer substrates do not. The polymer of the substrate 12 may be a matrix 14 for holding a filler 16. Particular types of polymers that Applicants have found to work well include polyester polymers, acrylate polymers and, particularly, methyl methacrylate polymers. Good filler materials within the polymer include oxides, particularly, oxides of aluminum such as aluminum trihydrate. More details concerning polymer systems that may be suitable for use in the present invention are discussed in, for example, U.S. Pat. Nos. 6,004,663; 5,882,560; 5,807,954; 5,747,154, 5,708,066; 5,662,846; 5,286,290; 5,272,230; 5,252,644; 5,250,596, 5,243,003; 5,145,903; 5,134,210; 5,073,587; 4,722,960; 4,678,819; 4,643,921; 4,413,089; 4,246,163; 4,183,991; 4,159,301; 4,107,135 and 3,847,865, the entire disclosure of each being hereby incorporated by reference herein. One particularly suitable filled polymer is CORIAN® plastic sold by Dupont of Wilmington, Del. and, another is Carolite™ plastic sold by Carolina Custom Surfaces of Greensboro, N.C.

An evaluation conducted and reported by DuPont Corian® Research and Development has examined the effects of chemical exposure to Corian® to help define its limits for use in chemical laboratories. Several samples of Corian®, including light and dark colors, were tested with 20 chemicals for surface damage effects. In addition, samples were also exposed to some of the harshest reagents and tested for changes in mechanical strength (flexural properties), impact resistance and surface hardness.

Surface Exposure to Chemical Reagents

A chemical spot test procedure similar to ANSI Z124.6 Section 5.2 was used to evaluate the chemical resistance of Corian®. Several drops of each reagent were placed on the surface covered under a watch glass and left overnight (approximately 16 hours). The Table 1 lists reagents used, their effect on Corian® the surface.

TABLE 1
Chemical Testing and Performance

| Reagents | Effect on Corian ® |
|---|---|
| Acids: | No effect |
| 10% acetic acid | No visible surface change |
| 0.10 M nitric acid (HNO₃) | |
| 0.10 M hydrochloric acid (HCl) | |
| Bases | |
| 0.10% sodium hydroxide | |
| concentrated ammonium | |
| hydroxide | |
| Oxidizers | |
| Concentrated sodium | |
| hypochlorite | |
| 15% sodium hypochlorite | |
| Bases | Slight |
| 10% sodium hydroxide | Barely visible |
| Solvents | deglossing of surface |
| Carbon tetrachloride (CCl₄) | |
| Acetone | |
| Toluene | |
| Acids | Moderate |
| 10.M nitric acid | Visible deglossing or slight etching |
| Bases | |
| *50% sodium hydroxide | |
| Solvent | |
| methyl ethyl ketone | |
| Acids | Pronounced |
| *glacial acetic acid | Surface change with slightly raised or |
| | moderate etching |
| Solvent | |
| chloroform (CHCl₃) | |
| methyl methacrylate | |
| Acids | Very Pronounced |
| *aqua regia | Significant raised or etched surface |
| *11 M nitric acid (HNO₃) | |
| 10 M hydrochloric acid (HCl₃) | |
| Solvents | |
| Methylene chloride (CH₂Cl₂) | |
| *These reagents are very strong, corrosive solutions used with extreme care under a fume hood to conform with | |
| # health and safety requirements. | |

General Conclusions from the Chemical Exposure Test:

Corian® is resistant to strong bases.

Corian(® was not affected by the oxidizing agent tested.

Strong acids can effect the surface of Corian® if left on the surface. There is little or no effect if cleaned up within a reasonable time (15-20 minutes).

Organic solvents such as methylene chloride (CH₂Cl₂), chloroform (CHCl₃) or methyl ethyl ketone (MEK) can produce significant surface marring if left on the surface. With long exposure to very strong acids and some solvents, the surface of Corian® can be significantly etched, softened or raised and will require sanding and buffing to renew the surface. It is most likely that strong acids would be used with extreme care, but organic solvents are used more liberally and could limit the use of Corian® in some labs. The best practice is to install a test piece of material to confirm the suitability of Corian® for the application.

Mechanical Testing

To quantify the practical risk of chemical exposure to the mechanical integrity of a Corian® installation, several tests were performed. Pieces of Corian® were subjected to simulated spills of three chemicals: 1.0M nitric acid, methylene chloride, and acetone. Ten milliliters of each reagent was placed on the surface, the spill was covered with a plastic lid, and the lid was weighted. These samples were left overnight and tested the following day.

Impact Strength

The impact resistance of the materials was tested using the ball-drop test. The test materials and a control were supported on a metal frame prescribed by the ASTM Z3029 procedure. The test was continued to a maximum impact of 4 lbs.×10 feet. In all cases, we were unable to break the samples. It was found that all the samples performed equal to control, so the chemical spills did not affect the bulk impact resistance.

Impact strength After the surface was marred by chemical exposure, the samples were milled to provide INSTRON test bars. In this process, the damaged area was milled off so the observed mechanical properties represent any change to the “internal” integrity of the Corian®. All samples were equal to control, again confirming that the bulk properties were not affected by the spills.

Surface hardness The surface hardness showed clearly the effects of chemical attack. HNO₃ (1.0 molar) did not significantly lower the hardness. The acetone had some effect, but would only require buffing with a Scotch-Brite pad to remove all marring. Methylene chloride had the greatest effect, as expected. However, when the sample was lightly sanded, as it would be to renew the appearance, the hardness of the fresh surface was equal to that of the control.

The properties of Corian® plastic make it suitable for environmentally stable signage able to withstand chemically and/or physically harsh environments. New and improved environmentally stable signage may withstand environmental factors such as environmental chemistry including acid compounds in air pollution, radiation including solar radiation and thermophysical fluctuations including thermal cycling discussed above. Also, these properties permit the formation of integral tactic indicia. Furthermore, the properties permit the formation of substantially perpendicular ascending and descending side between terraces. Applicants believe that Carolite™ plastic possess similar characteristics.

The combination of the size and amount of the filler within the polymer matrix 14 is such that it permits the use of the substrate 12 in the etching process to create the indicia that is distinguished from the background. This is particularly important with respect to the tactile indicia 24. The size, shape and distribution of the filler 16 is such that the tactile indicia 24 communication of the signage is not confused or obfuscated by the presence of roughness due to the filler 16 within the polymer matrix 14.

Applicants believe that the signage 10 of the present invention may be made by using numerous techniques or equipment and have found that the technique using an etcher 40 is beneficial. The substrate 12 having the properties that are desirable for the resultant signage is placed in the substrate holder 46. The etchent delivery 42 may include a nozzle 54 for directing the etchent 44 such as a pressurized fluid onto the surface of the signage 10. To create the visual indicia 22 on the signage 10, a mask 20 is placed onto the substrate 12 surface to protect the surface from the etchent 44. The etchent 44 is then directed to the surface of the substrate 12 and in areas where there is no mask 20 the substrate 12 is etched, and in locations where there is a mask 20, the substrate 12 is retained.

An aspect of the present invention is that the impingement of the etchent 44 is substantially perpendicular to the surface of the signage 10 which creates a good step between the resultant background of the signage 10 and the communicative indicia 22 and 24. The etchent 44 is delivered to the surface and as noted, it may be a pressurized fluid. Examples of pressurized fluids include a gas such as air. Applicants have found that by providing an abrasive grit 56 in air at a pressure of about 30 to about 40 pounds per square inch, good results are obtained. Abrasive grit 56 may also include oxides, which are known in the art. One type of oxide that Applicants have used includes an oxide of aluminum having a particle size of about 100 grit.

To create the signage 10 according to the present invention there is relative movement of the etchent delivery 42 or nozzle 54 over the surface of the substrate 12 at a predetermined distance and speed such that the etching depth is substantially uniform over the substrate 12. This creates clarity in the resultant signage 10, and clarity in the sense that the communicative indicia including visual symbols, alphanumeric symbols and Braille are distinct from the background. To accomplish this, the movement of the etchent delivery 42 and the substrate holder 46 is performed along a major and a minor axis movement in a controlled way to be constant and consistent. The movement occurs as the etchent 44 is delivered and a movement mechanism 60 is used to accomplish this.

The movement can be done either by the movement of the etchent delivery 42, the movement of the substrate holder 46, or the movement of both. Applicants have found that the spacing between the etchent delivery 42 and the substrate holder 46 is important as well as that the speed of the etchent delivery 42 is important. These factors are determined by the composition of the substrate 12.

To accomplish the desired results in the signage, a controller 50 can be included in the etcher 40. The controller 50 can be of the type known in the industry. More details concerning a controller that may be used in etcher 40 are discussed in, for example, U.S. Pat. Nos. 5,980,078; 5,726,912; 5,689,415; 5,579,218; 5,351,200; 4,916,600; 4,344,127; and 4,646,223, the entire disclosure of each being hereby incorporated by reference herein. The etcher 40 in combination with the controller 50 might include mechanisms and provisions for regulating the pressure at which the etchent is delivered. This combination might also regulate and set the predetermined spacing 64 between the etchent delivery 42, the substrate holder 46, and, in particular, the substrate surface 12 for regulating and maintaining the speed of the relative movement of the etchent delivery 42 and the substrate holder 46.

Further, the etcher 40 may include a movement mechanism or mechanisms 60 to provide for the relative movement of the etchent delivery 42 and the substrate holder 46 along a major axis and a minor axis to regulate the consistent etching of the background to create the indicia in a signage. More details concerning a movement mechanism or mechanisms that may be used in etcher 40 are discussed in, for example, U.S. Pat. Nos. 5,872,892; 4,979,093; 4,835,710; 4,417,845; 4,352,620; and 4,068,156, the entire disclosure of each being hereby incorporated by reference herein. Finally, the etcher 40 and the controller 50 might include provisions for monitoring the depth and consistency of the etching to not only set a stop point but also to permit the consistent etching depth and also to permit the system to correct any problems that might have occurred in the etching process to create a consistently etched signage. More details concerning provisions for monitoring the depth and consistency of the etching that may be used in etcher 40 are discussed in, for example, U.S. Pat. No. 5,042,949, the entire disclosure of which is hereby incorporated by reference herein.

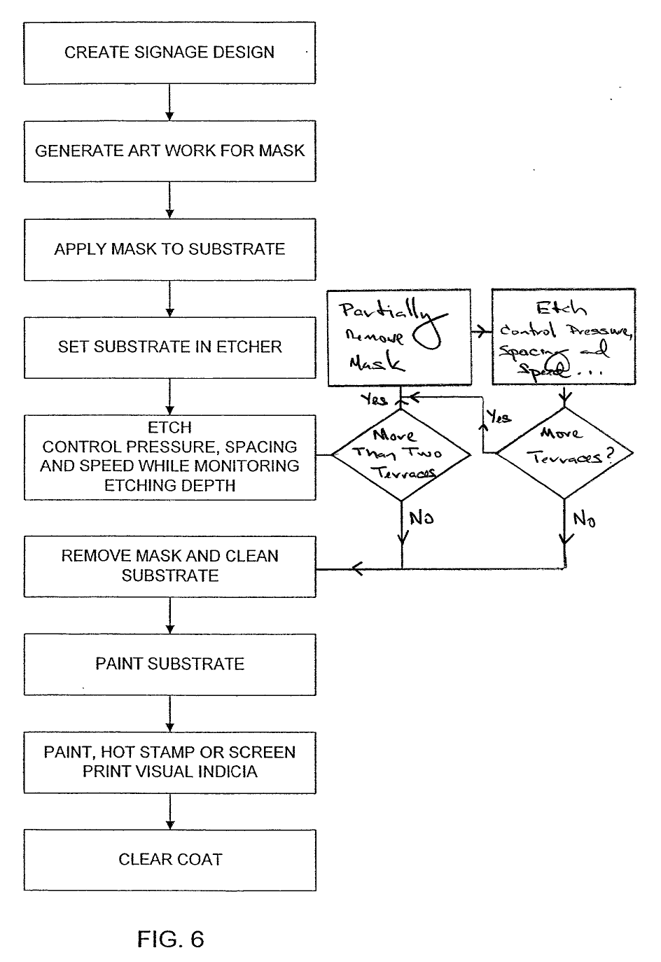

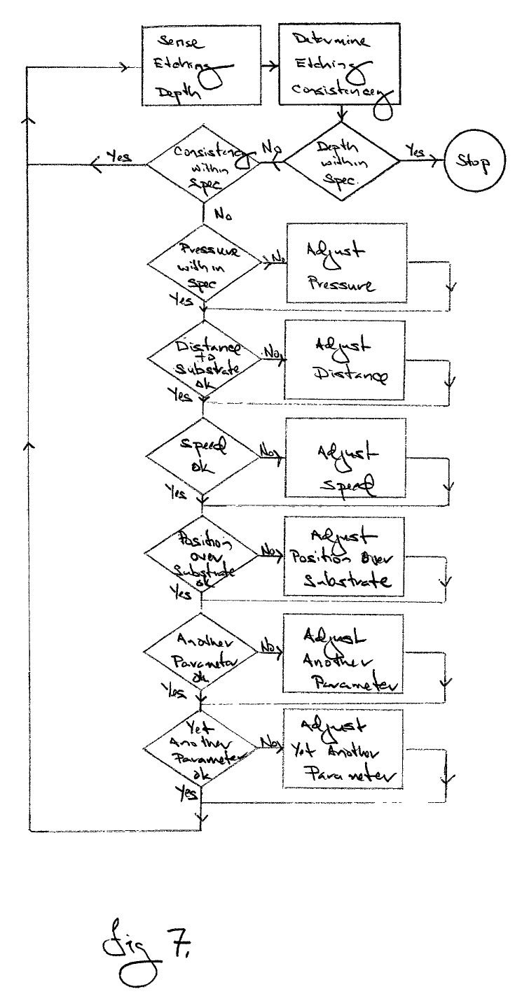

FIG. 6 depicts a flow chart showing a method for making signage 10 according to the present invention. FIG. 7 depicts a flow chart showing a control method for making signage 10 according to the present invention. Although FIG. 7 shows serial processing of parameters, parallel processing as well as parallel together with serial processing is also contemplated. In an aspect of the present invention, first a design for signage 10 is obtained. The design may include alphanumeric information, as well as symbolic information. The artwork for these may be developed by using a computer system that might interface with the controller 50.

In operation, once the art is generated, the mask work 20 to be applied to the substrate 12 is generated and that mask work 20 is processed and placed on the substrate 12. A suitable mask material is a yellow stencil mask (part # 802245) available from Accu-Cut Systems of Fremont, Nebr. The substrate 12 is then etched and cleaned. More details concerning equipment that may be used for etching are discussed in, for example, U.S. Pat. Nos. 3,407,539; 3,372,704; 3,307,296; 3,298,137; 3,286,406; 3,103,084; and Des. 246,108, the entire disclosure of each being hereby incorporated by reference herein. The etched and cleaned substrate 12 is then painted with a background color. Different technologies might be used to apply the lettering or indicia coloring to the alphanumeric or symbolic information. Different technologies that have been used include hot stamping and screen-printing. Finally, a clear coat 34 may be applied to the entire signage 10 to add an additional provision for protecting the signage 10 from environmental effects.

Certain modifications and improvements will occur to those skilled in the art upon a reading of the foregoing description. It should be understood that all such modifications and improvements have been deleted herein for the sake of conciseness and readability but are properly within the scope of the following claims.

We claim:

1. A method for forming a substrate for use in architecturally aesthetic signage complying with the requirements of the Americans for Disabilities Act comprising:
(a) providing an environmentally stable substrate;
(b) delivering an etchent to a surface of said substrate to remove at least a portion of said substrate;
(c) creating at least two terraces by said removal of said at least a portion of said substrate whereby one terrace defines indicia on the other terrace of said surface;
(d) controlling said delivering to said surface of said substrate to uniformly etch said at least a portion of said terraced substrate; and
(e) cleaning said terraced substrate, wherein said substrate has a sufficient hardness that upon interaction with said etchent results in said at least two terraces having smooth corresponding visual indicia and tactile indicia for communication with an at least partially blind observer; and

2. The method according to claim 1, wherein said controlling includes regulating the pressure of said delivery of said etchent.

3. The method according to claim 3, wherein said controlling includes regulating a predetermined spacing between said delivery of said etchent and said substrate.

4. The method according to claim 1, wherein said controlling includes regulating a speed of a relative movement of said delivery of said etchent and said substrate.

5. The method according to claim 1, wherein said controlling includes driving a relative movement of said delivery of said etchent and said substrate along a major axis and a minor axis.

6. The method according to claim 1, wherein said controlling includes regulating etching depth.

7. A method for forming a substrate for use in architecturally aesthetic signage complying with the requirements of the Americans for Disabilities Act comprising:
(a) providing an environmentally stable substrate;
(b) delivering an etchent to a surface of said substrate to remove at least a portion of said substrate;
(c) creating at least two terraces by said removal of said at least a portion of said substrate whereby one terrace defines indicia on the other terrace of said surface;
(d) cleaning said terraced substrate, wherein said substrate has a sufficient hardness that upon interaction with said etchent results in said at least two terraces having smooth corresponding visual indicia and tactile indicia for communication with an at least partially blind observer; and
(e) applying contrasting colors to said substrate, one color applied to said terrace of said indicia and another color applied to said other terrace.

8. The method according to claim 7, wherein said smooth surfaces comprise multiple terraces.

9. The method according to claim 7, wherein said tactile and visual indicia comply with the requirements of the Americans for Disabilities Act.

10. The method according to claim 7, wherein said indicia includes lettering and is formed from a second color coating different from said first color coating.

11. The method according to claim 10, further including a clear coat over at least the lettering of said signage.

12. The method according to claim 7, wherein said substrate is a polymer.

13. The method according to claim 12, wherein said polymer includes a filler.

14. The method according to claim 13, wherein said filler is an oxide.

15. The method according to claim 14, wherein said oxide is an oxide of aluminum.

16. The method according to claim 15, wherein said filled polymer is at least one of CORIAN® plastic and Carolite™ plastic.

17. The method according to claim 13, wherein the particle size of said filler is large enough to permit etching and small enough to permit the formation of clear distinguishing smooth surfaces.

18. The method according to claim 12, wherein said polymer is at least one of an acrylic polymer and a polyester polymer.

19. The method according to claim 12, wherein said polymer is a methyl methacrylate polymer.

20. The method according to claim 7, wherein a mask is applied to said substrate to create said indicia on said surface.

21. The method according to claim 20, wherein an adhesive is applied between said mask and said substrate.

22. The method according to claim 20, wherein said mask is resistant to the etching process.

23. The method according to claim 7, wherein said delivering an etchent to said surface includes delivering through a nozzle.

24. The etcher method to claim 23, wherein the exit angle from said nozzle is substantially perpendicular to said substrate.

25. The method according to claim 7, wherein said etchent includes a pressurized fluid.

26. The method according to claim 25, wherein said pressurized fluid is a compressed gas.

27. The method according to claim 26, wherein said compressed gas is air.

28. The method according to claim 25, wherein said pressurized fluid is delivered at a pressure sufficient to produce even etching.

29. The etcher method to claim 28, wherein said pressure is between about 30 and 40 pounds per square inch.

30. The method according to claim 25, wherein said pressurized fluid further includes an abrasive grit.

31. The method according to claim 30, wherein said abrasive grit is an oxide.

32. The method according to claim 31, wherein said oxide has a particle size of about 100 grit.

33. The method according to claim 31 wherein said oxide is an oxide of aluminum.

34. An etcher for forming a substrate for use in architecturally aesthetic signage complying with the requirements of the Americans for Disabilities Act, said etcher comprises:
(a) an etchent delivery;
(b) an etchent;
(c) a substrate holder; and
(d) a controller for controlling the delivery of the etchent onto said substrate to form said signage.

35. An etcher system for forming a substrate for use in architecturally aesthetic signage complying with the requirements of the Americans for Disabilities Act, said system comprising:
(a) an etchent delivery;
(b) an etchent;
(c) a substrate holder; and
(d) a substrate having sufficient hardness that upon interaction with the etchent results in a plurality of smooth surfaces resulting in visual indicia for communication with an observer.

36. An etcher system for forming a substrate for use in an architecturally aesthetic signage complying with the requirements of the Americans for Disabilities Act, said system comprising:
(a) an etchent delivery;
(b) an etchent;
(c) a substrate holder;
(d) a substrate having sufficient hardness that upon interaction with the etchent results in a plurality of smooth surfaces resulting in visual indicia for communication with an observer; and
(e) a controller for controlling the delivery of the etchent onto said substrate to form said signage.

37. Architecturally aesthetic signage for complying with the requirements of the Americans for Disabilities Act, said signage comprising a substrate having sufficient hardness that upon interaction with an etchent results in enviromnentally stable signage having at least two terraces whereby one terrace defines visual and tactile indicia on the other terrace, contrasting colors in which one color is applied to at least the visual portion of the indicia containing terrace and another color applied to said other terrace, resulting in both visual and tactile indicia for communication to an observer, even if partially blind.

38. The signage according to claim 37, wherein said smooth surfaces further includes multiple terraces.

39. The signage according to claim 38, further including a first color coating on a first terrace.

40. The signage according to claim 39, further including a second color coating on a second terrace.

41. The signage according to claim 40, wherein said indicia includes lettering wherein said indicia is formed from a second color coating different from said first color coating.

42. The signage according to claim 41, further including a clear coat over at least the lettering portion of said signage.

43. The signage according to claim 37, wherein said substrate is formed from a polymer.

44. The signage according to claim 43, wherein said polymer includes a filler.

45. The signage according to claim 44, wherein said filler is an oxide.

46. The signage according to claim 45, wherein said oxide is an oxide of aluminum oxide.

47. The signage according to claim 45, wherein said filled polymer is one of a CORIAN® plastic and a Carolite™ plastic.

48. The signage according to claim 44, wherein the particle size of the filler is large enough to permit etching and small enough to permit the formation of clear distinguishing smooth surfaces.

49. The signage according to claim 43, wherein said polymer is at least one of an acrylic polymer and a polyester polymer.

50. The signage according to claim 43, wherein said polymer is a methyl methacrylate polymer.

51. The signage according to claim 37, wherein said tactile and visual indicia comply with the requirements of the Americans for Disabilities Act.

52. The signage according to claim 37, wherein said tactile indicia corresponds to said visual indicia.
